(19) United States
(12) Patent Application Publication
(10) Pub. No.: US 2007/0201698 A1
(43) Pub. Date: Aug. 30, 2007

(54) Key management device and method for providing security service in Ethernet-based passive optical network

(76) Inventors: Jae Doo Huh, Daejeon (KR); Su Il Choi, Daejeon (KR); Kyeong Hwan An, Daegu (KR); Ki Jun Han, Daegu (KR)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/796,072

(22) Filed: Apr. 26, 2007

Related U.S. Application Data
(62) Division of application No. 10/693,131, filed on Oct. 23, 2003.

(30) Foreign Application Priority Data
Jul. 9, 2003 (KR) 2003-46490

(51) Int. Cl. H04K 1/00

(52) U.S. Cl. 380/256

(57) ABSTRACT

A key management device and method which is required for provision of a security service in an EPON vulnerable to security breaches due to characteristics of Ethernet. A session key distribution function is performed in such a manner that, during the process of communication setup between an OLT and an ONU, the OLT multicasts a public key and the ONU receives the public key from the OLT and then distributes a corresponding session key to the OLT. A session key update function is performed in such a manner that an existing session key is updated with a new one through a periodic MPCP general gate message and an ONU report message.

### BACKGROUND OF THE INVENTION

1. Field of the Invention

The present invention relates to an Ethernet-based passive optical network (referred to hereinafter as ‘EPON’), and more particularly to a key management device and method which is required for provision of a security service in an EPON vulnerable to security breaches due to characteristics of Ethernet.

2. Description of the Related Art

In general, an EPON has a structure of using an optical distribution network (referred to hereinafter as ‘ODN’) or wavelength division multiplex (referred to hereinafter as ‘WDM’) device between a subscriber access node in the form of FTTH (Fiber To The Home) or FTTC (Fiber To The Curb/Cabinet) and optical network termination units (referred to hereinafter as ‘ONT’), wherein all nodes have a bus or tree-branch topology. The EPON has a point-to-multipoint architecture where a plurality of optical network units (referred to hereinafter as ‘ONUs’) share an optical line terminal (referred to hereinafter as ‘OLT’) through one optical fiber. That is, in the downstream direction, the OLT transmits messages to the ONUs in a broadcasting manner. Alternatively, in the upstream direction, the EPON has a point-to-multipoint architecture where the ONUs transmit messages to the OLT.

Data traffic on the Internet has grown rapidly since 1990. According to such an Internet services, recently, a backbone network has provided a bandwidth increasing up to the terabit class using a WDM technology or the optical transmission. Also, the data rate of a local area network (referred to hereinafter as ‘LAN’) is on an increasing trend from the 10/100 Mbps class to 10 Gbps at maximum. As a result, there has been a need for a new access network technology to provide a broadband service, and the EPON has been considered to be the best candidate for a next-generation access network.

FIG. 1 shows a flow of downstream message transmission from the OLT to the ONUs in the EPON.

With reference to FIG. 1, the OLT 110 resides in a central office and is connected with the ONUs 121, 122, . . . , 123 via an single optical cable 150. The ONUs 121, 122, . . . , 123 are installed within homes or companies and receive a variety of services, such as an Internet service, a telephony service and an interactive video service, from the OLT 110. In this EPON, Ethernet frames 140, 141, 142 and 143 containing data for various services are transmitted from the OLT 110 to each of the ONUs 121, 122, . . . , 123 via a 1:N passive optical splitter (or coupler), not shown. Here, the Ethernet frames 140, 141, 142 and 143 are each composed of a variable-length packet of up to 1518 bytes and include information regarding a destination ONU. Upon receiving such packets, each of the ONUs 121, 122, . . . , 123 adopts only a corresponding one or ones of the received packets while discarding the others, and then transfers the adopted packet or packets to a corresponding user 131, 132, . . . , or 133.

FIG. 2 shows a flow of upstream message transmission from the ONUs to the OLT in the EPON.

With reference to FIG. 2, the upstream transmission in the EPON is performed as follows. First, the users 131, 132, . . . , 133 transfer desired frames 211 to 216 to the corresponding ONUs 121, 122, . . . , 123, respectively. Then, the ONUs 121, 122, . . . , 123 transmit the corresponding frames to the OLT 110 via the optical cable 150 while carrying them in respective time slots 221, 222 and 223 pre-allocated by the OLT 110.

In the EPON, as described above, a plurality of ONUs must share one medium (optical cable) to transmit and receive data to/from one OLT. In this connection, a medium access control (referred to hereinafter as ‘MAC’) protocol is required to enable the ONUs to efficiently access the medium. According to this requirement, a multi-point control protocol (referred to hereinafter as ‘MPCP’) in the EPON uses a time division multiple access (referred to hereinafter as ‘TDMA’)-based mechanism to enable efficient transmission of upstream data between the ONUs and the OLT. The main functions of the MPCP are to control a discovery process of the OLT for the ONUs, to allocate time slots to the ONUs, and to provide a timing reference of the OLT and ONUs.

However, the above-mentioned data communication scheme in the EPON is disadvantageous in that it has a structure vulnerable to security breaches.

As data is broadcast in the downstream transmission of the EPON, security threats in the EPON are as follows. Firstly, all the ONUs subordinate to the OLT can eavesdrop downstream traffic from the OLT. Secondly, an attacker can know MAC addresses and logical link identifiers (referred to hereinafter as ‘LLIDs’) of the other ONUs. Thirdly, an attacker can infer the amount and type of traffic to the other ONUs by monitoring LLIDs and MAC addresses thereof. Fourthly, MPCP messages broadcast from the OLT can reveal upstream traffic characteristics of each of the ONUs.

The EPON has some security threats in the upstream transmission thereof. Firstly, an attacker can masquerade as another ONU using an LLID and MAC address thereof. Secondly, an attacker can flood the network with messages affecting the availability of network resources or OAM (Operation, Administration and Maintenance) information. Thirdly, after succeeding in hacking an OAM channel, an attacker can try to change an EPON system configuration. Fourthly, an attacker can disturb the EPON system by sending optical signals upstream. Fifthly, an attacker can perform a malicious security attack by intercepting upstream data using reflections from the EPON, modifying the intercepted data and sending the modified data to the OLT.

A representative example of approaches to the aforementioned security threats is shown in Korean Patent Application No. 10-2000-0017271 (ENCRYPTION KEY MANAGEMENT APPARATUS AND METHOD), in which there is disclosed an apparatus and method for preventing cipher hacking by adding an encryption function to hardware itself. Another approach is shown in a reference thesis (Rinat Khoussainov, “LAN Security: problems and solutions for Ethernet networks”, Computer Standards & Interfaces, Vol.22, No.2, pp. 191-202, 2000.8.1), in which there is disclosed a method for guaranteeing confidentiality and integrity of data on an Ethernet-based LAN.

FIG. 3 is a flow chart illustrating a conventional session key distribution procedure using the discovery process of the OLT for the ONUs.

With reference to FIG. 3, first, the OLT multicasts a discovery gate message GATE to all the ONUs (dest_addr=multicast) at step 310. Here, the discovery gate message contains a time slot field GRANT allocated to each of the ONUs for registration thereof, an OLT capability, a public key KU_{OLT} of the OLT, and a nonce E_{KROLT}[TIMESTAMP] encrypted by a private key of the OLT for signature.

At step 320, an arbitrary one of the ONUs sends a registration request message REGISTER_REQUEST to the OLT to respond to the discovery gate message. Here, the registration request message REGISTER_REQUEST contains a plaintext ONU temporary MAC address, and a physical ID capability, an ONU capability, an echo of the OLT capability, an ONU permanent MAC address and an ONU random temporary key, encrypted by the public key of the OLT.

At step 330, the OLT sends a registration message REGISTER to the ONU to notify it that it has been registered. Here, the registration message REGISTER contains the plaintext ONU temporary MAC address, and a physical ID list, an echo of the ONU capability, an echo of the ONU permanent MAC address and a 128-bit session key, encrypted by the ONU random temporary key.

At step 340, the OLT sends a general gate message GATE to the ONU to allocate it a time slot for upstream transmission thereof. Here, the general gate message contains the plaintext ONU temporary MAC address, and a time slot field GRANT encrypted by the session key.

Last, at step 350, the ONU sends a registration acknowledgement message REGISTER_ACK to the OLT to respond to the registration message REGISTER. Here, the registration acknowledgement message REGISTER_ACK contains an echo of the registered physical ID encrypted by the session key.

However, the above-mentioned conventional session key distribution procedure has the following problems. Firstly, it is inefficient that the registration request message has to contain the plaintext ONU temporary MAC address, and the ONU permanent MAC address encrypted by the public key of the OLT. The ONU temporary MAC address is used to send the registration request message to the OLT and receive the registration message therefrom. The ONU permanent MAC address is permanently used after the ONU discovery process is successfully performed. The ONU encrypts all fields of the registration request message except a source address using the public key of the OLT. In this regard, in order to provide a privacy security service, there is no choice but to employ as the source address the ONU temporary MAC address available only in the ONU discovery process. Secondly, it is inefficient to create two keys for a symmetric-key encryption algorithm in the ONU discovery process. One is the ONU random temporary key contained in the registration request message of the ONU and the other is the 128-bit session key contained in the registration message of the OLT. The ONU discovery process has a complex structure in that the registration message of the OLT is encrypted by the ONU random temporary key and the general gate message of the OLT and the registration acknowledgement message of the ONU are encrypted by the 128-bit session key. Thirdly, it is inefficient to encrypt all fields of the registration request message of the ONU except the ONU temporary MAC address using the OLT public key. Since a public key algorithm is lower in encryption speed than the symmetric-key algorithm, system performance is degraded when the message fields other than the ONU temporary MAC address are encrypted using the public key algorithm.

### SUMMARY OF THE INVENTION

Therefore, the present invention has been made in view of the above problems, and it is an object of the present invention to provide a device and method for key management between an OLT and an ONU, wherein a session key distribution function is performed in such a manner that, during the process of communication setup between the OLT and the ONU, the OLT multicasts a public key and the ONU receives the public key from the OLT and then distributes a corresponding session key to the OLT.

It is another object of the present invention to provide a method for key management between an OLT and an ONU, wherein a session key update function is performed in such a manner that an existing session key is updated with a new one through a periodic MPCP general gate message and an ONU report message.

It is yet another object of the present invention to provide a method for key management between an OLT and an ONU, wherein a key recovery function is performed in such a manner that, when an error occurs in private and public keys of an RSA public key algorithm, a pair of new private and public keys are created and the created public key is multicast through a periodic discovery gate message, and, when an error occurs in a session key of a symmetric-key algorithm, a new session key is transmitted to the OLT while being incorporated in a report message created using a time slot allocated in an ONU discovery process.

In accordance with one aspect of the present invention, the above and other objects can be accomplished by the provision of a key management device for provision of a security service in an Ethernet-based passive optical network, comprising: an optical line terminal for sending a discovery gate message to discover an optical network unit for data transmission, and, if the optical network unit receives the discovery gate message and then requests data communication, sending an encrypted registration message including a permanent medium access control (MAC) address of the optical network unit to the optical network unit to notify the optical network unit that it has been registered and an encrypted general gate message including the permanent MAC address of the optical network unit to the optical network unit to allocate a time slot to the optical network unit; and the optical network unit for receiving the discovery gate message and then sending an encrypted registration request message to the optical line terminal to request the data communication therewith and an encrypted registration acknowledgement message to the optical line terminal to respond to the registration message.

In accordance with another aspect of the present invention, there is provided a method for session key distribution between an optical line terminal and an optical network unit in a key management method for provision of a security service in an Ethernet-based passive optical network, comprising the steps of: a), by the optical line terminal, sending a discovery gate message to discover the optical network unit for data transmission; b), by the optical network unit, receiving the discovery gate message and then sending an encrypted registration request message to the optical line terminal to perform data communication therewith; c), by the optical line terminal, sending an encrypted registration message including a permanent MAC address of the optical network unit to the optical network unit to notify the optical network unit that it has been registered; d), by the optical line terminal, sending an encrypted general gate message including the permanent MAC address of the optical network unit to the optical network unit to allocate a time slot to the optical network unit; and e), by the optical network unit, sending an encrypted registration acknowledgement message to the optical line terminal to respond to the registration message.

In accordance with a further aspect of the present invention, there is provided a method for session key update between an optical line terminal and an optical network unit in a key management method for provision of a security service in an Ethernet-based passive optical network, comprising the steps of: a), by the optical line terminal, sending key update information to the optical network unit at a predetermined key update period; and b), by the optical network unit, receiving the key update information and sending a new session key to the optical line terminal.

In accordance with another aspect of the present invention, there is provided a method for key recovery between an optical line terminal and an optical network unit in a key management method for provision of a security service in an Ethernet-based passive optical network, comprising the steps of: a) determining whether a pair of private and public keys are in error; b), if the pair of private and public keys are in error, by the optical line terminal, creating a pair of new private and public keys and multicasting the new public key while including it in a desired message; and c), by the optical network unit, receiving the new public key, comparing it with a public key pre-stored in a public key storage unit therein, discarding the new public key if it is the same as the pre-stored public key and storing the new public key in the public key storage unit if it is different from the pre-stored public key.

In accordance with yet another aspect of the present invention, there is provided a method for key recovery between an optical line terminal and an optical network unit in a key management method for provision of a security service in an Ethernet-based passive optical network, comprising the steps of: a) determining whether there is a session key error between the optical line terminal and the optical network unit; and b), if there is a session key error between the optical line terminal and the optical network unit, by the optical network unit, sending a new session key to the optical line terminal using a time slot sent while being included in a discovery gate message.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing a flow of downstream message transmission from an OLT to ONUs in an EPON;

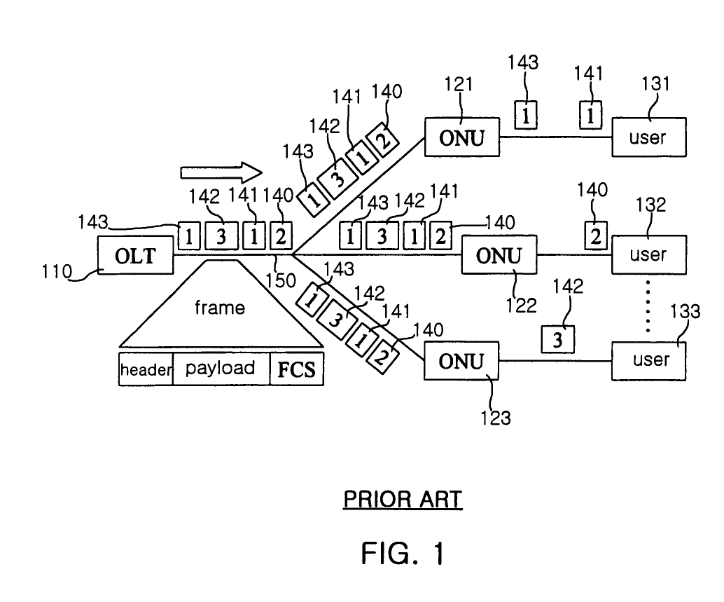

FIG. 2 is a view showing a flow of upstream message transmission from the ONUs to the OLT in the EPON;

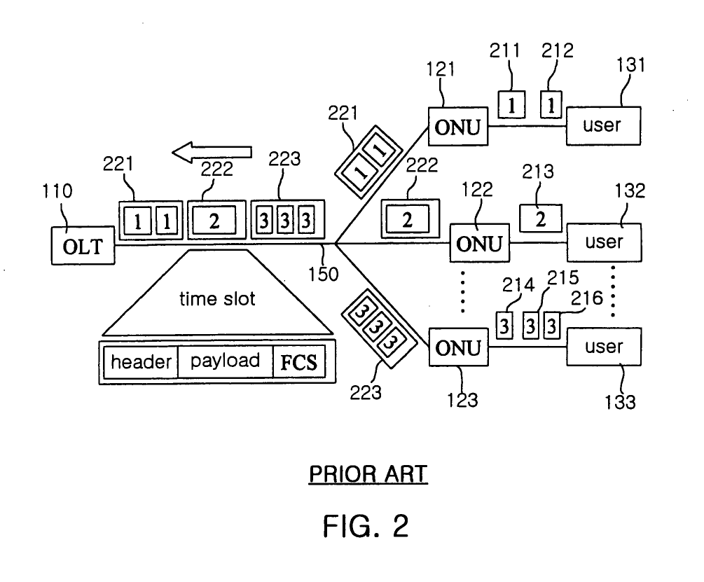

FIG. 3 is a flow chart illustrating a conventional session key distribution procedure using a discovery process of the OLT for the ONUs;

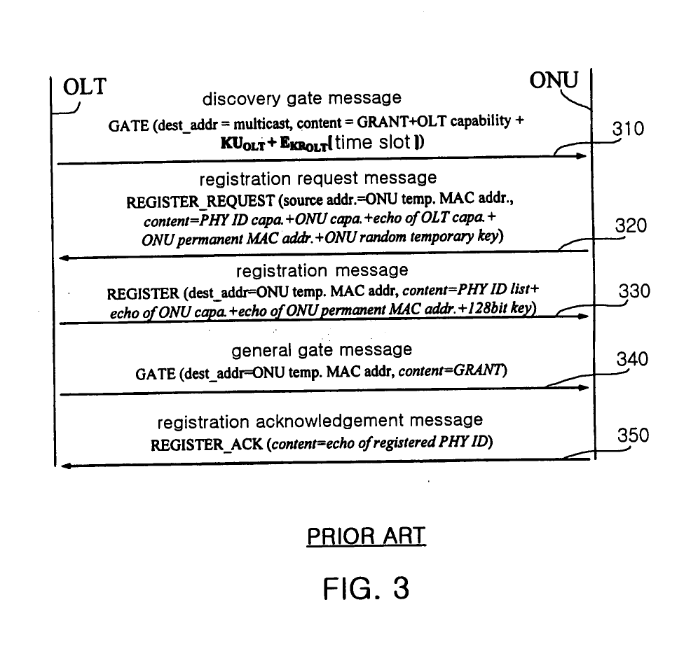

FIG. 4 is a block diagram showing the configuration of a key management device for provision of a security service in an EPON according to the present invention; and

FIG. 5 is a flow chart illustrating a session key distribution procedure in a key management method for provision of the security service in the EPON according to the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description of the present invention, a detailed description of known functions and configurations incorporated herein will be omitted when it may make the subject matter of the present invention rather unclear.

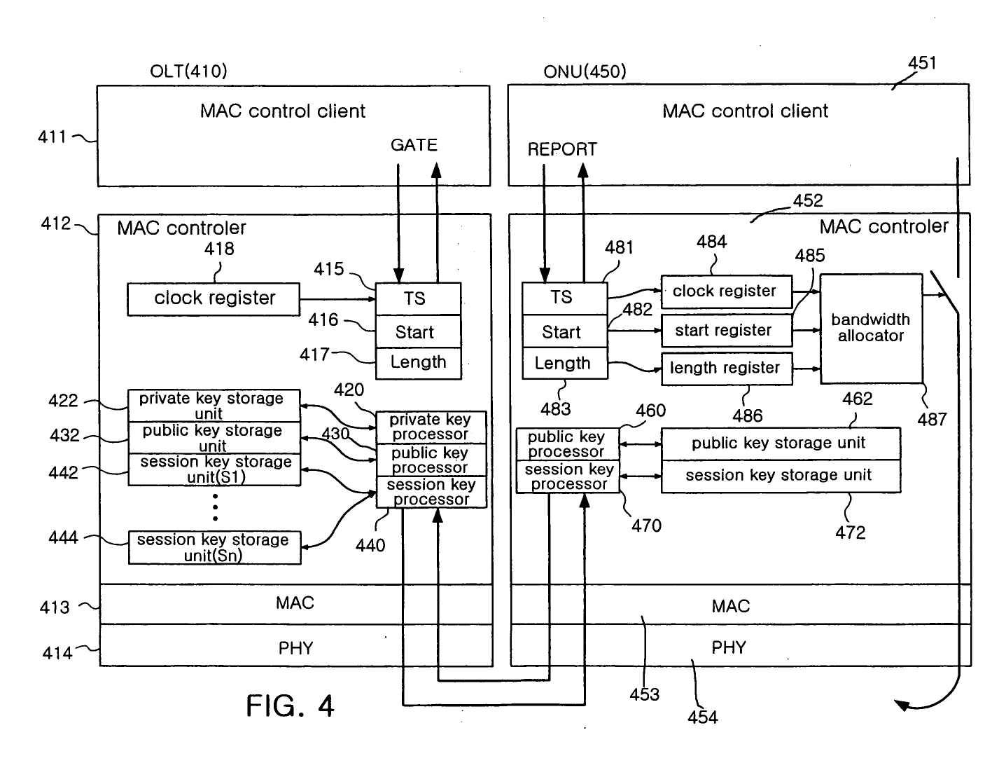

With reference to FIG. 4, there is shown in block form the configuration of a key management device for provision of a security service in an EPON according to the present invention.

As shown in FIG. 4, the key management device according to the present invention comprises, for key distribution, an OLT 410 including an MAC control client 411 and MAC controller 412, and an ONU 450 including an MAC control client 451 and MAC controller 452.

The MAC control client 411 in the OLT 410 performs a layer 2 switching function and a layer 3 application program interface (referred to hereinafter as ‘API’) function. The MAC control client 411 in the OLT is a point-to-multipoint communication module and is adapted to process a multi-ONU interface. The MAC control client 451 in the ONU is an API for performing the layer 2 switching function, which is a module for point-to-point communication with the OLT 410. The MAC controllers 412 and 452 are each adapted to control medium access from a subscriber on a corresponding one of MAC layers 413 and 453. Physical layers 414 and 454 each provide a connection point to a physical transmission medium such as an optical fiber or twisted pair.

A detailed description will hereinafter be given of the operation and configuration of the key management device according to the present invention.

The OLT 410 periodically multicasts a public key through a discovery gate message. The ONU 450 encrypts a registration request message and registration acknowledgement message using a session key and sends the encrypted messages to the OLT 410. The ONU 450 also encrypts the session key using the public key of the OLT 410 and sends the encrypted session key to the OLT 410 to enable decryption of the messages encrypted by the session key. The OLT 410 must decrypt the messages sent from the ONU 450 using its private key. This private key is created using the public key. In this connection, the MAC controller 412 in the OLT includes a private key processor 420 for creating, encrypting and decrypting the private key, and a public key processor 430 for creating, encrypting and decrypting the public key. The MAC controller 412 in the OLT further includes a private key storage unit 422 for storing and managing the private key, and a public key storage unit 432 for storing and managing the public key. Since the EPON has a point-to-multipoint architecture where one OLT provides services to a plurality of ONUs, the OLT has to manage respective session keys of the ONUs. To this end, the MAC controller 412 in the OLT further includes session key storage units 442, . . . , 444 for storing and managing the session keys of the plurality of ONUs, respectively, and a session key processor 440 for encrypting and decrypting the session keys on the basis of a symmetric-key algorithm. The MAC controller 412 in the OLT further includes a time stamp generator 415 for generating a time stamp to measure a delay in the network, a clock register 418 for providing a clock to the time stamp generator 415, a start indicator 416 for indicating a message start, and a length indicator 417 for indicating a message length.

On the other hand, the ONU 450 is in point-to-point relation with the OLT 410. In this connection, the MAC controller 452 in the ONU includes a public key storage unit 462 for storing and managing the public key of the serving OLT 410, and a public key processor 460 for encrypting and decrypting the public key. The MAC controller 452 in the ONU further includes a session key storage unit 472 for storing and managing a session key shared with the OLT 410, and a session key processor 470 for creating, encrypting and decrypting the session key. The MAC controller 452 in the ONU further includes a time stamp generator 481 for generating a time stamp to measure a delay in the network, a clock register 484 for storing the time stamp, a start indicator 482 for indicating a message start, a start register 485 for storing the message start, a length indicator 483 for indicating a message length, a length register 486 for storing the message length, and a bandwidth allocator 487 for transmission management. The bandwidth allocator 487 acts to allocate a bandwidth to the ONU on the basis of the time stamp, message start and message length information and send it to the OLT.

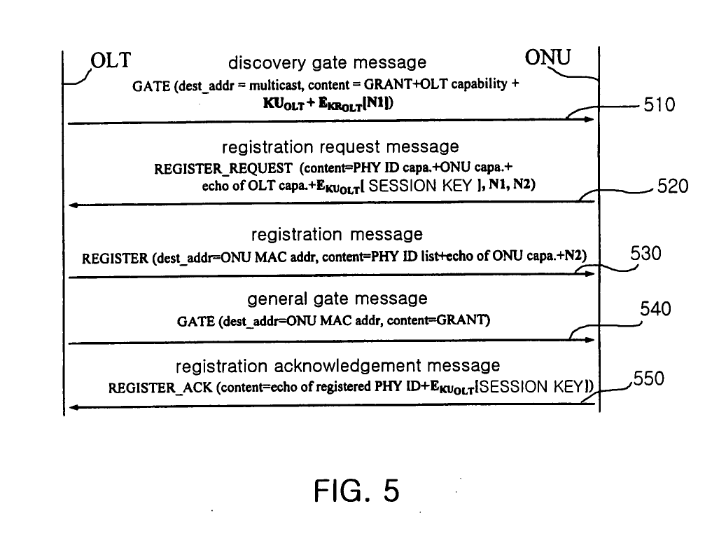

FIG. 5 is a flow chart illustrating a session key distribution procedure in a key management method for provision of the security service in the EPON according to the present invention.

With reference to FIG. 5, first, at step 510, the OLT periodically multicasts a plaintext discovery gate message GATE (dest_addr=multicast) to perform a discovery process for a destination ONU. Here, the discovery gate message contains a time slot field GRANT allocated to the destination ONU for registration thereof, an OLT capability, a public key KU_{OLT} of the OLT, and a nonce (time stamp) E_{KROLT}[N1] encrypted by a private key of the OLT for signature.

At step 520, if the destination ONU receives the discovery gate message, then it sends a registration request message REGISTER_REQUEST to the OLT to respond to the discovery gate message. Here, the registration request message REGISTER_REQUEST contains a physical ID capability, an ONU capability, an echo of the OLT capability, a session key E_{KUOLT}[SESSION KEY] encrypted by the public key of the OLT, the nonce N1 decrypted by the OLT public key, and a nonce N2 created for signature of the ONU. All fields of the registration request message except the session key encrypted by the OLT public key are encrypted using the session key.

At step 530, the OLT decrypts the registration request message sent from the ONU using the session key and then sends a registration message REGISTER to the ONU to notify it that it has been registered.

Here, the registration message REGISTER contains an ONU permanent MAC address (dest_addr=ONU MAC addr), a physical ID list, an echo of the ONU capability, and the ONU signature N2.

At step 540, the OLT sends a general gate message GATE to the ONU for upstream transmission thereof. Here, the general gate message contains the ONU permanent MAC address (dest_addr=ONU MAC addr), and a time slot field GRANT for allocation of a time slot. The general gate message is encrypted by the session key.

Last, at step 550, the ONU sends a registration acknowledgement message REGISTER_ACK to the OLT to respond to the registration message REGISTER.

Here, the registration acknowledgement message REGISTER_ACK contains the session key E_{KUOLT}[SESSION KEY] encrypted by the public key of the OLT, and an echo of the registered physical ID. The registration acknowledgement message is encrypted by the session key and then transferred to the OLT.

The session key distribution according to the present invention is accomplished in the above manner. Further, the present invention proposes a periodic session key update procedure and a procedure of session key recovery from data transmission errors in the key management method for provision of the security service in the EPON.

The session key update procedure according to the present invention will hereinafter be described in detail with reference to FIG. 4.

First, the OLT 410 periodically sends a general gate message to the ONU 450 to allocate a time slot thereto. The ONU 450 can request bandwidth allocation from the OLT 410 through a report message REPORT which is an upstream message. The present invention proposes a procedure of updating a session key between the OLT 410 and the ONU 450 using such characteristics of the EPON. First, in consideration of a predetermined key update period, the OLT 410 periodically sends a general gate message to the ONU 450 to notify it that a session key must be updated, and the ONU 450 sends a report message REPORT with a new session key to the OLT 410. Then, the OLT 410 stores and manages the new session key sent from the ONU 450 in a corresponding one of the session key storage units 442, . . . , 444 therein, and the ONU 450 stores and manages the new session key in the session key storage unit 472 thereof. Notably, the EPON uses a Rivest-Shamir-Adleman (RSA) public key algorithm for key distribution and a symmetric-key algorithm for data encryption. Also, the OLT 410 distributes its public key and the ONU 450 distributes its session key. In this manner, the session key can be updated between the OLT 410 and the ONU 450.

In this process, however, key values may be damaged due to transmission errors between the OLT 410 and the ONU 450. Errors can occur in the private and public key pair and the session key between the OLT 410 and the ONU 450 as follows. An error in the private and public keys for the RSA public key algorithm may occur during transmission of a discovery gate message with the public key from the OLT 410 to the ONU. 450. Also, when the ONU 450 has a malfunction, there may be a pair of erroneous private and public keys between the OLT 410 and the ONU 450. An error may occur in the session key for the symmetric-key encryption algorithm during transmission of a registration request message in the discovery process of the OLT 410 for the ONU 450. Also, when the OLT 410 has a malfunction, there may be a session key error between the OLT 410 and the ONU 450. Further, the session key may be in error due to a transmission error in a report message of the ONU 450 during time slot allocation from the OLT 410 to the ONU 450.

Where errors occur in the private and public key pair and the session key in the EPON as stated above, a key recovery function could be performed between the OLT and the ONU, as will hereinafter be described in detail with reference to FIGS. 4 and 5.

First, the OLT 410 or ONU 450 determines whether there is an error in the private and public key pair. The OLT 410 or ONU 450 can detect a private/public key error by decrypting a received message using the session key and verifying a frame check sequence (referred to hereinafter as ‘FCS’) for the decrypted message. Upon detecting a private/public key error, the OLT 410 generates a pair of new private and public keys and then multicasts the new public key while including it in a discovery gate message. If the ONU 450 receives the discovery gate message with the new public key, then it compares the received public key with one pre-stored in the public key storage unit 462 thereof. If the two keys are the same, the ONU 450 discards the new public key. Otherwise, the ONU 450 stores the new public key in the public key storage unit 462 thereof to replace the pre-stored public key with the new one. As a result, the key recovery is accomplished.

Next, a description will be given of a procedure of key recovery between the OLT and the ONU when there is a session key error in the EPON.

First, the OLT 410 or ONU 450 determines whether there is a session key error. The session key can be determined to be in error when there is not continuously present any upstream transmission from the ONU 450 pre-allocated a time slot from the OLT 410. The reason is that, if there is a session key error, the ONU 450 cannot decrypt a general gate message and thus perform upstream transmission although it has been allocated a time slot from the OLT 410. Further, a session key error can be determined to have occurred between the ONU 450 and the OLT 410 when the ONU 450 receives a discovery gate message periodically transmitted from the OLT 410, but does not continuously receive a general gate message from the OLT 410. If the session key is in error, it is impossible for the ONU 450 to receive a general gate message from the OLT 410 and thus to be allocated a normal time slot from the OLT 410. Therefore, using a time slot allocated through a discovery gate message in the ONU discovery process by the OLT 410, the ONU 450 transmits a report message with a new session key to the OLT 410 to accomplish the session key recovery.

As apparent from the above description, the present invention provides a key management device and method for provision of a security service in an EPON that has the following effects.

Firstly, the key management device and key management method can be easily implemented. All MPCP messages except a discovery gate message of an OLT are encrypted in a key management process, thereby allowing the use of only one permanent MAC address of an ONU. This can reduce unnecessary waste of address space and omit mapping between an ONU temporary MAC address and the ONU permanent MAC address, thereby making the configuration of the key management device simpler and the implementation of the key management method easier. In particular, if the ONU receives the discovery gate message from the OLT, then it creates a session key for encryption between the OLT and the ONU and distributes the created session key to the OLT while including it in a registration request message. Therefore, the present method can provide an encryption scheme simpler than that in a conventional method wherein a random temporary key created and distributed by the ONU is managed separately from a session key created and distributed by the OLT.

Secondly, message encryption performance can be enhanced. The key management device and method according to the present invention can provide higher encryption performance in that all message fields except a session key field in upstream transmission are encrypted using a symmetric-key algorithm.

Thirdly, an enhanced security service can be provided. Both confidentiality and privacy can be provided by encrypting all MPCP messages except a discovery gate message of an OLT.

Fourthly, the key management can be improved by providing a session key update procedure and a session key recovery procedure, as well as a session key distribution procedure.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for session key update between an optical line terminal and an optical network unit in a key management method for provision of a security service in an Ethernet-based passive optical network, comprising the steps of:
a), by said optical line terminal, sending key update information to said optical network unit at a predetermined key update period; and
b), by said optical network unit, receiving said key update information and sending a new session key to said optical line terminal.

2. The session key update method as set forth in claim 1, further comprising the steps of:
c), by said optical line terminal, storing said session key from said optical network unit in a storage unit allocated thereto; and
d), by said optical network unit, storing said session key in a session key storage unit therein.

3. The session key update method as set forth in claim 1, wherein said key update information is sent to said optical network unit through a general gate message.

4. The session key update method as set forth in claim 1, wherein said new session key is sent to said optical line terminal through a report message.
